(19) United States
(12) Patent Application Publication
(10) Pub. No.: US 2008/0290634 A1
(43) Pub. Date: Nov. 27, 2008

(54) Curtain side-airbag device

(75) Inventors: Sakae Sugimori, Tokyo (JP); Kenji Nakamura, Tokyo (JP)

Correspondence Address: KANESAKA BERNER AND PARTNERS LLP, 1700 DIAGONAL RD, SUITE 310, ALEXANDRIA, VA, 22314-2848, US

(73) Assignee: TAKATA CORPORATION, Tokyo (JP)

(21) Appl. No.: 12/010,953

(22) Filed: Jan. 31, 2008

(30) Foreign Application Priority Data
May 25, 2007 (JP) 2007-138987

(51) Int. Cl. B60R 21/21

(52) U.S. Cl. 280/728.2; 280/730.2

(57) ABSTRACT

A curtain side-airbag device includes an airbag extending from front to rear of a vehicle, a plurality of inflatable support portions provided in the airbag and communicating with each other, and an inflator. The airbag is maintained in a folded state and secured in a vehicle body so that the airbag extends along an upper edge of an inner side surface of a vehicle cabin. The airbag is deployed in a form of a curtain along the inner side surface of the vehicle cabin. The airbag has an upper edge, a non-inflatable peripheral portion surrounding the inflatable support portions, and a strap provided between the upper edge and the non-inflatable peripheral portion of the airbag. The strap regulates a direction of deployment upon inflation of the inflatable support portions.

### BACKGROUND OF THE INVENTION AND RELATED ART STATEMENTS

The present invention relates to curtain side-airbag devices, and particularly, to a curtain side-airbag device that is deployable in the form of a curtain along a side surface of a vehicle, such as door windows, in the event of a side collision or rollover of the vehicle.

In a vehicle equipped with a curtain side-airbag device, a curtain side-airbag is folded in an elongate shape to extend in the longitudinal direction of the vehicle and is stored within a cover molding extending from front to rear of the vehicle cabin at an upper section of an inner side surface of the vehicle cabin. When the vehicle is involved in a side collision or predicts an accident with a collision sensor, the folded-and-stored curtain side-airbag becomes inflated and deployed. Such a curtain side-airbag has a bag-shaped inflatable portion formed of basic cloth, which inflates and deploys downward in the form of a curtain between an occupant and the inner side surface of the vehicle cabin, such as a door window and a pillar, thereby restraining the movement of the occupant towards the inner side surface.

In this technical field, curtain side-airbag devices that avoid contact with interior materials, such as center pillars and trimmings, at the time of deployment thereof to allow the curtain side-airbag devices to be deployed into a proper shape have already been proposed. This is achieved by providing a curtain side-airbag device with a sliding mechanism at a garnish section of a center pillar and also with a strap between the front and rear ends of the curtain side-airbag and a part of the vehicle body (Patent Document 1: Japanese Unexamined Patent Application Publication No. 2002-337648).

The applicant has co-developed a curtain airbag device that allows proper and efficient mounting of a tip end portion of the curtain airbag to a front pillar. This is achieved by providing a plurality of mounting sections extending from a tip end of the basic cloth of the curtain airbag and fixing the tip ends of the mounting sections together onto the front pillar (Patent Document 2: Japanese Unexamined Patent Application Publication No. 2005-350019).

In the inventions disclosed in Patent Documents 1 and 2, a deployment delay caused by contact between the curtain side-airbag and interior materials at the time of deployment of the curtain airbag along a window is prevented by fixing one end of an elongate strap extending from the airbag onto a part of the vehicle body. However, this creates an additional mounting process when the side-airbag device folded into a module is to be mounted onto the vehicle body. In addition, depending on the cell shape of the curtain airbag, there are cases where the shape of the curtain airbag may tend to cause the curtain airbag to partially come into contact easily with the interior materials at the time of deployment. For example, the cell portion for restraining a side of the head of an occupant in the rear seat tends to be easily affected by the shape of the rear pillar. For this reason, it is preferable that this cell portion be given a shape that can avoid contact with the pillar at the time of deployment.

Accordingly, an object of the present invention is to provide a curtain side-airbag device that prevents a curtain side-airbag from coming into contact with an interior material in the event of a side collision so as to achieve a quick and smooth deployment of the curtain side-airbag.

Further objects and advantages of the invention will be apparent from the following description of the invention.

### SUMMARY OF THE INVENTION

In order to achieve the aforementioned object, the present invention provides a curtain side-airbag device that includes an airbag extending from front to rear inside a vehicle cabin and having a plurality of inflatable support portions communicating with each other. The airbag is maintained in a folded state and secured to a part of a vehicle body so that the airbag extends along an upper edge of an inner side surface of the vehicle cabin. The curtain side-airbag device actuates an inflator at the time of a collision or prediction of a collision to introduce gas into the airbag, and the gas inflates the inflatable support portions and allows the airbag to be deployed in a form of a curtain along the inner side surface of the vehicle cabin. In the curtain side-airbag device, an upper edge of the airbag and a non-inflatable peripheral portion surrounding the inflatable support portions have a strap provided therebetween. The strap regulates a deployment direction during the inflation of the inflatable support portions.

In this case, a tip end of the strap extending from the upper edge of the airbag may be fixed to the non-inflatable peripheral portion surrounding the inflatable support portions. In contrast, a tip end of the strap extending from the non-inflatable peripheral portion surrounding the inflatable support portions may be fixed to the upper edge of the airbag.

Preferably, the strap extends to an airbag rear-end located rearward of a connection position of the strap on the upper edge of the airbag, and the tip end of the strap is fixed to the non-inflatable peripheral portion at the airbag rear-end. Alternatively, the strap preferably extends to a section of the upper edge of the airbag located forward of an airbag rear-end, and the tip end of the strap is preferably fixed to a part of the vehicle body together with a vehicle-body mounting tab of the airbag. Accordingly, the airbag can be properly deployed without the airbag rear-end coming into contact with an interior material of, for example, a rear pillar.

The strap preferably has a length shorter than that of the airbag between a connection position of the strap and a fixing position of a tip end of the strap. Accordingly, when the airbag inflates, the strap receives a predetermined tension and can thus properly regulate the deployment direction of the airbag.

The strap is preferably folded towards the vehicle cabin from a connection position of the strap and has a tip end that is fixed to a fixing position such that the strap is positioned at a vehicle-cabin facing side of the airbag. Accordingly, this avoids contact between the airbag and interior materials, thereby ensuring the deployment of the airbag.

The strap is preferably folded towards a window from a connection position of the strap and has a tip end fixed to a fixing position such that the strap is positioned at a window-facing side of the airbag. Accordingly, a tension acting on the strap can allow the airbag to be deployed without protruding excessively towards the vehicle cabin.

The strap is preferably cut from a basic cloth integrally with a cloth constituting the airbag. Accordingly, a working process for attaching the strap to the airbag can be omitted.

According to the present invention, the contact between interior materials and the airbag at the time of deployment can be minimized to enable a quick and smooth deployment of the curtain side-airbag.

### BRIEF DESCRIPTION OF THE DRAWINGS

FIGS. 1(a)-1(b) are schematic front views of a curtain side-airbag device according to a first embodiment of the present invention.

FIGS. 2(a)-2(c) are a partial perspective view and cross-sectional views showing a state where a deployment control tab, shown in FIGS. 1(a)-1(b), is attached.

FIGS. 3(a)-3(b) are schematic front views of a curtain side-airbag device according to a second embodiment.

FIG. 4 is a partial perspective view showing a state where a deployment control tab shown in FIG. 3 is attached.

FIGS. 5(a)-5(b) are schematic front views of a curtain side-airbag device according to a modified example of the second embodiment.

FIG. 6 is a partial perspective view showing a state where a deployment control tab shown in FIG. 5 is attached.

FIGS. 7(a)-7(b) are schematic front views of a curtain side-airbag device according to a third embodiment.

FIGS. 8(a)-8(b) are schematic front views of a curtain side-airbag device according to a fourth embodiment.

FIGS. 9(a)-9(c) are schematic front views of a curtain side-airbag device according to a fifth embodiment.

FIGS. 10(a)-10(c) are schematic plan views of the curtain side-airbag devices according to the first, third, and fourth embodiments.

FIGS. 11(a)-11(c) are schematic plan views of the curtain side-airbag device according to the fifth embodiment.

### DETAILED DESCRIPTION OF PREFERRED EMBODIMENTS

A plurality of embodiments of a curtain side-airbag device according to the present invention will now be described with reference to the attached drawings.

### First Embodiment

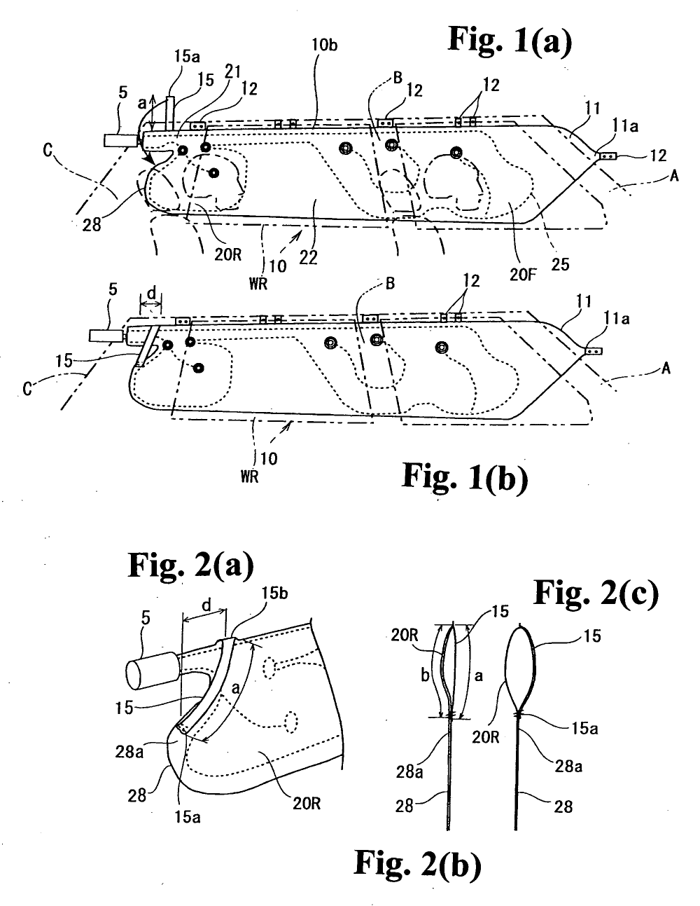

FIG. 1 includes front views of a curtain side-airbag device 10 (referred to as a curtain airbag 10 hereinafter) deploying along a left side surface inside a vehicle cabin 1. Specifically, FIG. 1(a) illustrates a pre-fixed state of a tip end 15a of a deployment control tab 15, and FIG. 1(b) illustrates a state where the tip end 15a of the deployment control tab 15 is sewn and fixed to a non-inflatable portion 28a located at the rear end of the curtain airbag 10. As shown in FIGS. 1(a) and 1(b), the curtain airbag 10 has a mounting tab 12 provided at an apex 11a of a substantially triangular non-inflatable end portion 11, and a plurality of mounting tabs 12, along an upper edge 10b in the longitudinal direction. With these mounting tabs 12, the apex 11a is fixed to a vehicle-body anchor section (not shown) of a front pillar A by means of a bolt, and the upper edge 10b is secured to anchor sections (not shown) provided along a roof side rail (not shown) extending in the front-rear direction of the vehicle, whereby the upper edge 10b extends along a line among an upper end of the front pillar A, an upper end of a center pillar B, and an upper end of a rear pillar C.

In a folded state, the curtain airbag 10 covers the roof side rail and is stored within a longitudinal lid (not shown) functioning as a divider molding between the ceiling and the side surface of the vehicle for design purposes. Although curtain airbags 10 are disposed at both left and right sides within the vehicle cabin 1, the description provided below will be directed to the curtain airbag 10 at the left side of the vehicle cabin 1. The overall structure of the curtain airbag 10 will now be described.

When an in-vehicle acceleration sensor (not shown) detects an acceleration higher than or equal to a threshold value at the time of a side collision of the vehicle or prediction of a side collision, an agent contained in an inflator 5 connected to a gas inlet 10c located at the rear end of the curtain airbag 10 is ignited. This generates emission gas in the inflator 5, which is introduced into the curtain airbag 10 to inflate the curtain airbag 10. As a result, the curtain airbag 10 pushes open the lid covering the roof side rail (not shown), so as to deploy downward in the form of a curtain from the upper edge of the side surface of the vehicle at a substantially consistent speed with respect to a direction from front to rear of the vehicle.

Similar to a known curtain airbag 10, the curtain airbag 10 according to the present invention is prepared by cutting two layers of basic cloth into substantially the same shape that is elongate in the front to rear direction so that the two elongate layers have a length that substantially extends from the front pillar A to the rear pillar C of the vehicle body. The two layers are then overlapped one on top of the other and are sewn together along the outer periphery thereof. Moreover, the two layers are further sewn together to form a contour line 25 having a predetermined pattern that defines inflatable support portions 20, a gas inlet path 21, and a non-inflatable portion 22. The inflatable support portions 20 mainly include a front-seat inflatable support portion 20F and a rear-seat inflatable support portion 20R, and the non-inflatable portion 22 is disposed therebetween.

The range in which the front-seat inflatable support portion 20F extends is defined by the contour line 25. Specifically, this range of the front-seat inflatable support portion 20F completely covers a slidable range of the front seat below the gas inlet path 21 in accordance with the front-seat occupant's physique. Likewise, the range in which the rear-seat inflatable support portion 20R extends is defined by the contour line 25, and covers a range in accordance with the rear-seat occupant's physique. Some vehicles of recent types have reclining rear seats, and the rear-seat inflatable support portion 20R according to the first embodiment can cover a range for a reclined state of the rear-seat occupant. Therefore, as shown in FIG. 1(a), an airbag rear-end 28, located rearward of the rear-seat inflatable support portion 20R and below the gas inlet path 21, has a protruding shape.

The deployment control tab 15, which is one of characteristics of the present invention, will now be described. As shown in FIG. 1(a), the deployment control tab 15 according to the first embodiment extends upward substantially perpendicularly from the upper edge 10b of the curtain airbag 10, which has the gas inlet path 21 that continuously extends from the gas inlet 10c of the inflator 5. The deployment control tab 15 is formed integrally with the curtain airbag body at the phase of basic cloth and cut into an elongate shape. In the first embodiment, the deployment control tab 15 is defined by a strap with a width of 20 mm and a length of 200 mm. The strap has a reinforcement cloth of the same dimensions set and sewn thereon and can obtain a strength for a predetermined tension. As shown in FIG. 1(b) and FIG. 2(a) (i.e. a partial perspective view as viewed from the rear side of the curtain airbag 10), the deployment control tab 15 has its tip end 15a securely sewn to the non-inflatable portion 28a of the airbag rear-end 28 at the time of a sewing process of the curtain airbag 10.

In the first embodiment, the airbag rear-end 28 is positioned at a distance d rearward a connection position 15b of the deployment control tab 15. Furthermore, as shown in a schematic cross-sectional view in FIG. 2(b), the deployment control tab 15 has a length a and is sewn such that the relationship (b>a) is satisfied with respect to a dimension b (length) of the curtain airbag 10 between the upper edge of the curtain airbag body and the fixing position of the tip end 15a of the deployment control tab 15. Thus, as shown in a schematic cross-sectional view in FIG. 2(c), when the rear-seat inflatable support portion 20R inflates, the deployment direction of the airbag rear-end 28 is regulated by the deployment control tab 15. Accordingly, when the curtain airbag 10 is inflated, the airbag rear-end 28 can be deployed at a substantially proper position without expanding in between the rear pillar C and a rear-seat window WR (see FIG. 1(b)) or protruding excessively towards the occupant.

The operation of the curtain airbag 10 and the advantage of the deployment control tab 15, according to the first embodiment having the above-described structure, will be described briefly with reference to FIGS. 1(a) and 1(b). In the following embodiments to be described below, the deployment control tab 15 obtains similar advantages at the time of deployment of the curtain airbag 10.

Normally, in all types of airbag devices for vehicles, collision sensors detect or predict accidents, and they actuate inflators in order to inflate airbags. In other words, in the curtain airbag 10, a plurality of collision sensors (not shown), set at predetermined positions of the vehicle body, can send signals for collision detection to an electronic control unit (ECU). Based on those signals from the corresponding collision sensors, the ECU identifies the type of accident as, for example, a side collision (or a rollover) of the vehicle and outputs an actuation signal to an agent igniter of the inflator 5 so that the curtain airbag 10 is deployed for restraining the occupants.

More specifically, when the type of accident, such as a side collision or a rollover of the vehicle, is identified based on the detection signals from multiple collision sensors of the plurality of collision sensors (not shown), the inflator 5 is actuated in response to a signal from the ECU. The inflator 5 thus generates gas, which is sent to the front-seat inflatable support portion 20F and the rear-seat inflatable support portion 20R via a gas supply tube (not shown) and the gas inlet path 21. As a result, the inflatable support portions 20 of the curtain airbag 10, stored along the roof side rail and covered by the lid, start to inflate. In response to this inflation, the lid covering the curtain airbag 10 is opened by being pushed downward, whereby the curtain airbag 10 inflates through the open section so as to deploy in the form of a curtain along the inner surface of the windows of the vehicle cabin 1. In order to allow the curtain airbag 10 to be deployed over the rear pillar C and the center pillar B, the deployment control tab 15 is provided. Consequently, the curtain airbag 10 can be deployed quickly without coming into contact with interior materials of, for example, the pillars at the time of deployment.

### Second Embodiment

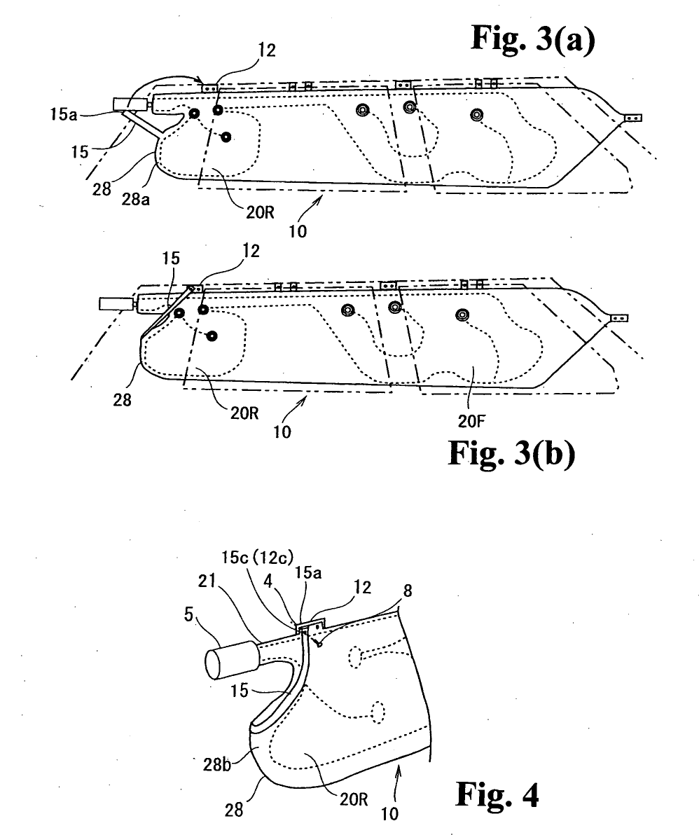

A second embodiment will now be described with reference to FIGS. 3(a), 3(b) and 4. As shown in FIG. 3(a), in the second embodiment, the deployment control tab 15 is a strap that is integrated with the non-inflatable portion 28a at the airbag rear-end 28, and that the tip end 15a of the strap is folded to one of the mounting tabs 12 of the curtain airbag 10 from the vehicle-cabin side and is fixed to a retainer 4 together with the mounting tab 12. As shown in FIG. 4, a mounting hole 15c provided at the tip end 15a of the deployment control tab 15 and a mounting hole 12c of the mounting tab 12 are aligned with each other and are screwed to the retainer 4 on the vehicle body by means of a fastening bolt 8, so that the deployment control tab 15 can be set at the time of installation of the curtain airbag 10. Although the advantage at the time of operation of the curtain airbag 10 in the second embodiment is the same as that in the first embodiment, the second embodiment is effective in saving labor the manufacturing process.

### Modified Example of Second Embodiment

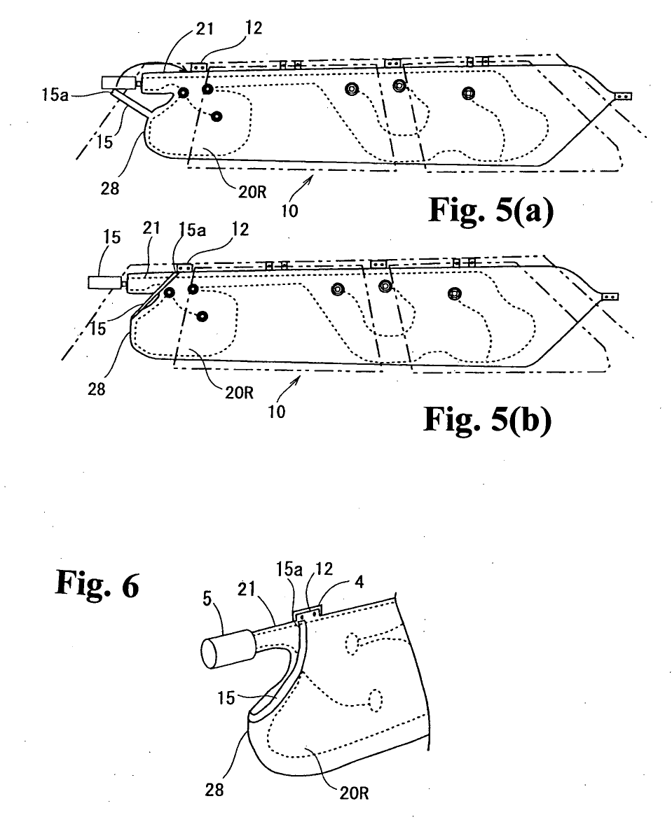

FIGS. 5(a), 5(b) and 6 illustrate a modified example of the second embodiment. This modified example is similar to the second embodiment in that the deployment control tab 15 is a strap that is integrated with the airbag rear-end 28, but differs from the second embodiment in that the tip end 15a of the deployment control tab 15 is sewn in alignment with the seam near one of the mounting tabs 12 at the upper side of the gas inlet path 21 during the sewing process of the curtain airbag 10. This is advantageous in view of handling since the deployment control tab 15, which is an elongate strap, can be packaged within the curtain airbag 10 in a folded state. The advantage at the time of operation of the curtain airbag 10 in this modified example is the same as that in the second embodiment.

### Third Embodiment

A third embodiment will now be described with reference to FIGS. 7(a) and 7(b). As shown in FIG. 7(a), in the third embodiment, the deployment control tab 15 is a strap that is integrated with a non-inflatable portion located near the center pillar B, and the tip end 15a of the strap is folded up to the non-inflatable portion 22 located rearward of the front-seat inflatable support portion 20F of the curtain airbag 10 from the vehicle-cabin side and is sewn to a part of the non-inflatable portion 22. Accordingly, this avoids contact between the curtain airbag 10 and the interior material of the center pillar B at the time of deployment of the curtain airbag 10, whereby the entire curtain airbag 10 can be deployed downward evenly. The fixing position of the tip end 15a of the deployment control tab 15 is not limited to the position shown in FIG. 7(b) (i.e. an intermediate position of the non-inflatable portion 22). For example, the tip end 15a may be fixed to a position of the non-inflatable portion 22 along the center pillar B and near the lower edge of the curtain airbag 10. This is also preferable since the inflatable support portions 20 can be properly and entirely deployed downward near the center pillar B.

### Fourth Embodiment

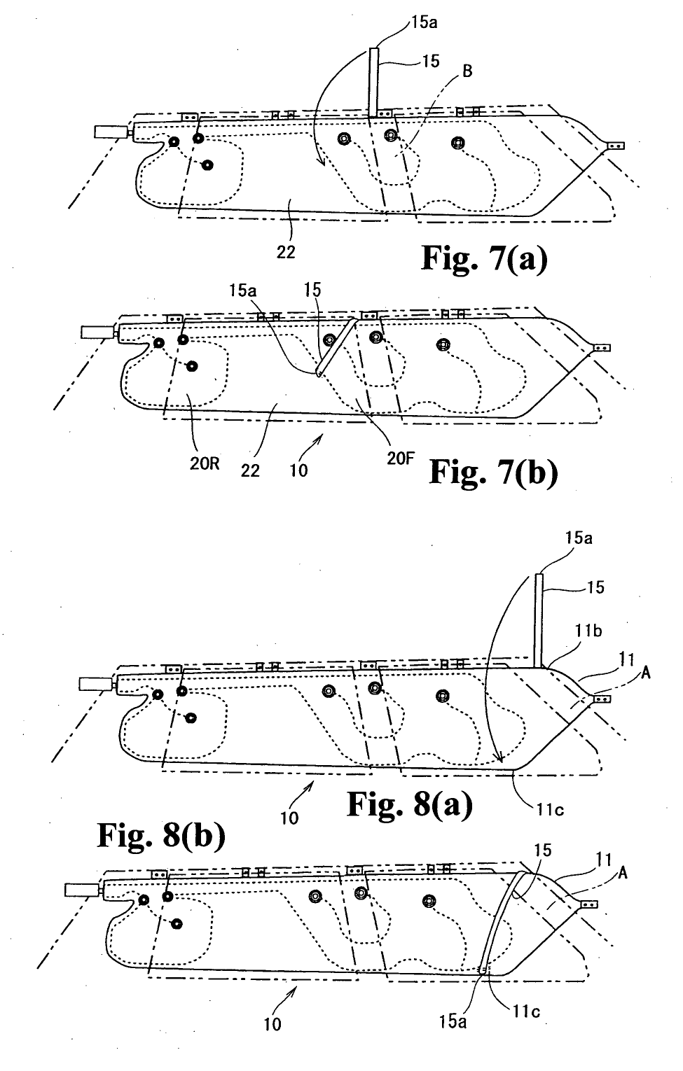

A fourth embodiment will now be described with reference to FIGS. 8(a), 8(b). As shown in FIG. 8(a), in the fourth embodiment, the deployment control tab 15 is a strap that is integrated with a shoulder section 11b of the non-inflatable end portion 11 of the curtain airbag 10, and that the tip end 15a of the strap is folded and sewn to a lower edge 11c of the non-inflatable end portion 11 at the vehicle-cabin side. Accordingly, this avoids contact between the non-inflatable end portion 11 and the interior material of the front pillar A at the time of deployment of the curtain airbag 10, thereby enabling smooth deployment of the tip end portion of the curtain airbag 10. The tip end 15a of the deployment control tab 15 is fixed to a position rearward of the connection position of the deployment control tab 15 as shown in FIG. 8(b), so that the curtain airbag 10 can be properly prevented from coming into contact with the interior material of the front pillar A at the time of deployment.

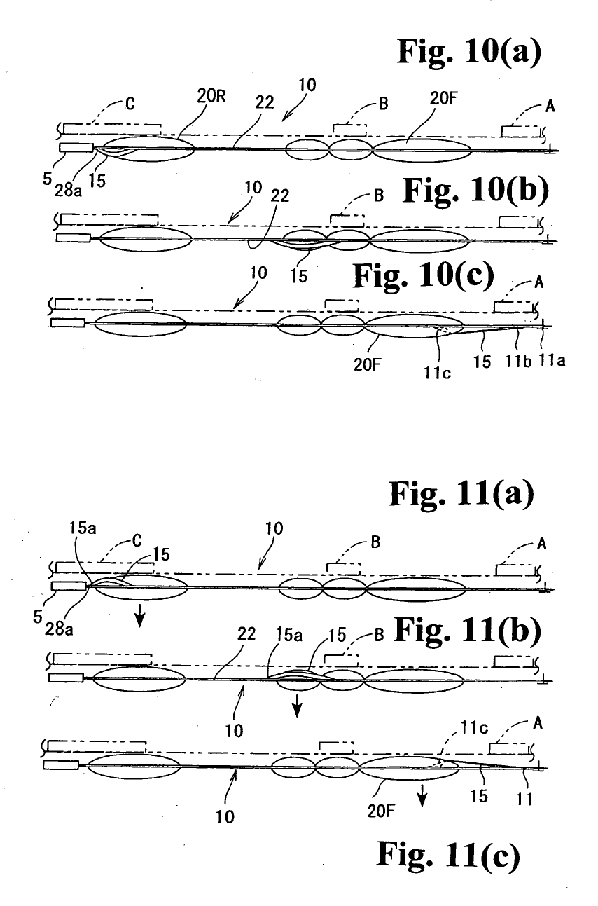

FIG. 10(a) to FIG. 10(c) are schematic diagrams showing attachment states of the deployment control tab 15 in the first to fourth embodiments when the curtain airbag 10 is inflated. As shown in each diagram, in the completely inflated state of the curtain airbag 10, the deployment control tab 15 can be positioned in close contact with the vehicle-cabin facing surface of the inflated curtain airbag 10 while receiving a predetermined tension.

### Fifth Embodiment

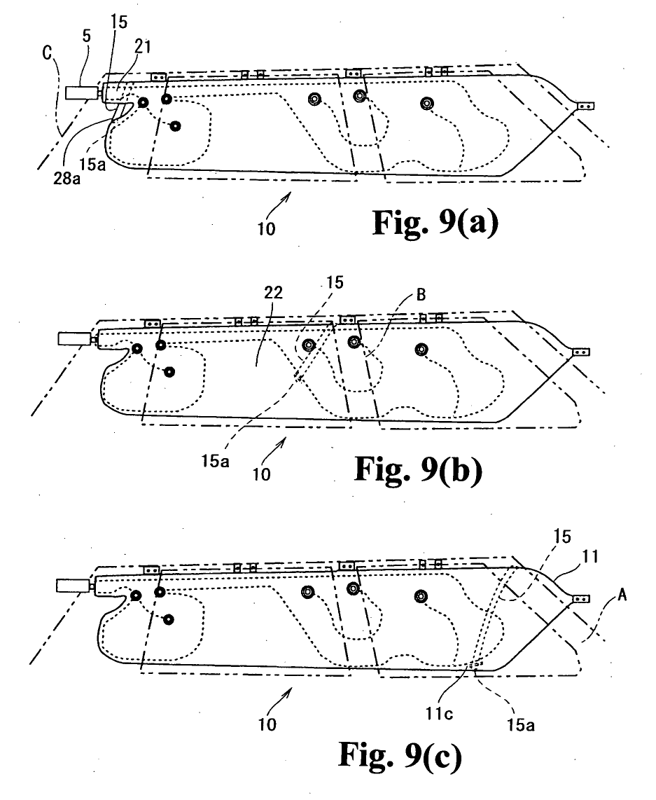

FIGS. 9(a), 9(b), and 9(c) illustrate the fifth embodiment, wherein the deployment control tab 15, shown in each of the first, third, and fourth embodiments, is folded toward a window-facing surface of the curtain airbag 10 from the connection position thereof, and the deployment control tab 15 is sewn to a fixing position on the window-facing surface. The fixing positions of the deployment control tab 15 on the window-facing surface in FIGS. 9(a), 9(b), 9(c) correspond to those on the vehicle-cabin facing surface of the curtain airbag 10 according to the first, third, and fourth embodiments, respectively. Accordingly, the deployment control tab 15 is disposed at the window-facing surface and attached to the curtain airbag 10, thereby preventing each portion of the curtain airbag 10 from being deployed away from the windows and protruding excessively towards the vehicle cabin 1.

FIGS. 11(a), 11(b), 11(c) are schematic diagrams showing attachment states of the deployment control tab 15 in the fifth embodiment when the curtain airbag 10 is inflated. As shown in each diagram, in the completely inflated state of the curtain airbag 10, the deployment control tab 15 of the corresponding attachment example can be positioned in close contact with the surface of the inflated curtain airbag 10 while receiving a predetermined tension. Consequently, with the tension resistance of the strap, each portion of the curtain airbag 10 can be prevented from protruding excessively towards the vehicle cabin 1 (i.e. in the direction of arrows) at the time of deployment. Although the fifth embodiment includes various attachment examples of the deployment control tab 15 attached to a corresponding position as shown in FIG. 9(a) to FIG. 9(c) and FIG. 11(a) to FIG. 11(c), a plurality of deployment control tabs 15 may be attached to multiple positions, thereby preventing the entire curtain airbag 10 from protruding towards the vehicle cabin 1 more effectively.

In each of the above embodiments, the deployment control tab 15 is cut as part of the curtain airbag 10 from basic cloth. Alternatively, the deployment control tab 15 may be a strap of a predetermined length that is preliminarily prepared as an independent component. In that case, the deployment control tab 15 may have its opposite ends sewn to corresponding positions of the curtain airbag 10 or may have an adhesive margin that ensures a predetermined adhesive strength. As a further alternative, the deployment control tab 15 may be attached to the curtain airbag 10 using various kinds of attaching devices that do not impair the material of the deployment control tab 15 or the curtain airbag 10.

The disclosure of Japanese Patent Application No. 2007-138987 filed on May 25, 2007 is incorporated as a reference.

While the invention has been explained with reference to the specific embodiments of the invention, the explanation is illustrative and the invention is limited only by the appended claims.

What is claimed is:

1. A curtain side-airbag device, comprising:
an airbag to be provided along an upper inner side surface of a vehicle cabin to extend from front to rear of the vehicle, said airbag having an upper edge, a plurality of inflatable support portions communicating with each other, and a non-inflatable peripheral portion surrounding the inflatable support portions;
an inflator for introducing gas into the airbag, said inflator being actuated in an event of a collision or prediction of the collision to inflate the inflatable support portions to develop along an inner side surface of the vehicle cabin; and
a strap provided between the upper edge and the non-inflatable peripheral portion, the strap regulating a direction of deployment of the non-inflatable peripheral portion upon inflation of the inflatable support portions.

2. The curtain side-airbag device according to claim 1, wherein the strap extends from the upper edge of the airbag and includes a tip fixed to the non-inflatable peripheral portion.

3. The curtain side-airbag device according to claim 1, wherein the strap extends from the non-inflatable peripheral portion and includes a tip fixed to the upper edge of the airbag.

4. The curtain side-airbag device according to claim 2, wherein the strap extends to a rear end of the airbag located rearward of a connection position of the strap on the upper edge of the airbag, and the tip end of the strap is fixed to the non-inflatable peripheral portion at the rear end.

5. The curtain side-airbag device according to claim 3, wherein the strap extends to the upper edge of the airbag located forward of a rear end of the airbag, and the airbag further includes a vehicle body mounting tab, the vehicle body mounting tab and the tip end of the strap being fixed to a part of the vehicle body together.

6. The curtain side-airbag device according to claim 1, wherein the strap is shorter than a length of the airbag between a connection position of the strap and a fixing position of a tip end of the strap.

7. The curtain side-airbag device according to claim 1, wherein the strap is folded towards the vehicle cabin from a connection position of the strap and has a tip end fixed to a fixing position so that the strap is positioned at a side of the airbag facing the vehicle cabin.

8. The curtain side-airbag device according to claim 1, wherein the strap is folded towards a window from a connection position of the strap and has a tip end fixed to a fixing position so that the strap is positioned at a side of the airbag facing the window.

9. The curtain side-airbag device according to claim 1, wherein the airbag and the strap are integrally formed together from a basic cloth as one structure.

10. The curtain side-airbag device according to claim 1, wherein said airbag has a gas inlet at one side of the upper edge, and a lower rear end located rearwardly from the gas inlet, said strap connecting the lower rear end to a portion adjacent the gas inlet to extend obliquely upon inflation of the airbag.
